(19) United States
(12) Patent Application Publication
(10) Pub. No.: US 2022/0411211 A1
(43) Pub. Date: Dec. 29, 2022

(54) Method for Multimodal Transportation and Apparatus for the Same

(71) Applicants: Hyundai Motor Company, Seoul (KR); Kia Corporation, Seoul (KR)

(72) Inventors: Jae Jun Ha, Hwaseong-si (KR); Young Jun Moon, Sejong-si (KR)

(21) Appl. No.: 17/723,659

(22) Filed: Apr. 19, 2022

(30) Foreign Application Priority Data
Jun. 24, 2021 (KR) 10-2021-0082652

(51) Int. Cl. B65G 67/00; B64F 1/32

(52) U.S. Cl. CPC B65G 67/00; B64F 1/32

(57) ABSTRACT

An embodiment method for multimodal transportation in a multimodal transportation system includes confirming freight transfer approval information provided by a freight transfer object that approaches a multimodal transportation facility, setting an entry lane for freight handling in a stop facility in response to a demand for freight handling of the freight transfer object, and controlling freight loading or unloading of the freight transfer object that passes the set entry lane for freight handling.

### CROSS-REFERENCE TO RELATED APPLICATIONS

The present application claims the benefit of Korean Patent Application No. 10-2021-0082652, filed on Jun. 24, 2021, which application is hereby incorporated herein by reference.

### TECHNICAL FIELD

The present disclosure relates to a method and apparatus for multimodal transportation.

### BACKGROUND

Next-generation mobilities such as the urban air mobility (UAM) and the personal air vehicle (PAV) have been devised to overcome the limitations of the existing means of transportation running on the ground and to travel in the three-dimensional space. Unlike the traditional means of aviation transport including existing aircraft and helicopters, those next-generation mobilities are being developed to take off and land in various types of space without a separate large facility dedicated to take-off and landing.

### SUMMARY

The present disclosure relates to a method and apparatus for multimodal transportation. Particular embodiments relate to a method and apparatus for handling freight between different transportation objects.

Although next-generation mobilities do not require a large separate facility dedicated to take-off and landing, if a large number of next-generation mobilities are distributed, they are supposed to operate in a prearranged altitude zone under air control. Although the next-generation mobilities do not require a large separate facility dedicated to take-off and landing, a basic facility, which enables a next-generation mobility to take off and land, may be needed to control smoothly the movement or operation of the mobility.

Embodiments of the present disclosure provide a structure of a multimodal transportation system that is capable of effectively realizing freight loading or unloading by using a multimodal transportation object in an environment of a take-off and landing facility, which is required for the operation of a next-generation mobility.

Also, embodiments of the present disclosure provide a method and apparatus for loading or unloading freight quickly and effectively by utilizing a structure of a multimodal transportation system that is provided in a take-off and landing facility.

According to an embodiment of the present disclosure, a method for multimodal transportation may be provided. The method may include confirming, by a transportation management server that is provided in the multimodal transportation system and comprises a communication unit, at least one storage medium and at least one processor, freight transfer approval information provided by a freight transfer object that approaches a multimodal transportation facility, setting an entry lane for freight handling in a stop facility in response to a demand for freight handling of the freight transfer object, and controlling freight loading or unloading of the freight transfer object that passes the set entry lane for freight handling.

The setting of the entry lane for freight handling may include setting at least one lane among a plurality of entry lanes for freight handling, which are prepared in the multimodal transportation system, and providing the at least one lane to the freight transfer object.

The processing of the freight loading or unloading of the freight transfer object may include loading or unloading freight of the freight transfer object, which is located on the entry lane for freight handling, by controlling a freight transfer apparatus.

The loading or unloading of freight of the freight transfer object may include transferring the freight to the freight transfer object located on the entry lane for freight handling by controlling a freight transfer element provided in the freight transfer apparatus.

The loading or unloading of freight of the freight transfer object may include transferring the freight to the entry lane for freight handling by controlling the freight transfer element and loading the freight located in the freight transfer element by controlling a loading arm provided in the freight transfer apparatus.

The loading or unloading of freight of the freight transfer object may include transferring the freight to the entry lane for freight handling by controlling the freight transfer element and transferring the freight to a temporary freight rack adjacent to the freight transfer object.

The processing of the freight loading or unloading of the freight transfer object may include detecting a state in which the freight transfer object stops on the entry lane for freight handling, unloading the freight from a loading device of the freight transfer object, and transferring the loaded freight by controlling a freight transfer element.

The processing of the freight loading or unloading of the freight transfer object may include requesting the freight transfer object to switch the loading device to an open or closed state and confirming the open or closed state of the loading device.

The processing of the freight loading or unloading of the freight transfer object may include retrieving, from the freight transfer object, control of the loading device that controls opening or closing of the loading device provided in the freight transfer object and returning, to the freight transfer object, the control of the loading device that controls opening or closing of the loading device provided in the freight transfer object.

The setting of the freight transfer approval information may include providing freight information on at least one piece of transferred freight, determining at least one piece of freight that is to be transferred by the freight transfer object, and generating the freight transfer approval information corresponding to the at least one piece of freight that is determined.

The freight transfer approval information may include at least one among an identifier of the selected freight, an identifier of an object that will transfer the freight, information on a departure point of transfer, information on a destination of transfer, a departure time of transfer, and an arrival time of transfer.

The confirming of the freight transfer approval information may include receiving a message, which includes the freight transfer approval information, from the freight transfer object.

The message including the freight transfer approval information may include a message which is transmitted from a personal air vehicle and requests entry into the multimodal transportation facility.

The message including the freight transfer approval information may include a message which is transmitted from a moving object and notifies entry into the multimodal transportation facility.

The freight transfer object may include at least one of a freight transfer personal air vehicle and a freight transfer moving object.

The freight stop zone may include at least one of a freight air vehicle stop zone, in which the freight transfer personal air vehicle stops, and a freight moving object stop zone, in which the freight transfer moving object stops.

The setting of the at least one lane may include determining, by the transportation management server, the at least one lane based on a condition of the plurality of entry lanes for freight handling.

The setting of the at least one lane may include providing, by the transportation management server, the condition of the plurality of entry lanes for freight handling to the freight transfer object and providing, by the freight transfer object, the condition of the plurality of entry lanes for freight handling to a user and receiving an input of the at least one lane from the user.

The processing of the freight loading or unloading may include identifying a freight loading processing result and providing the freight loading processing result to the transportation management server or the freight transfer object.

Determining an alternative freight transfer object, which will be loaded with the freight, by considering the processing result may be included.

According to another embodiment of the present disclosure, a multimodal transportation system for processing freight transportation through a freight transfer object may be provided. The system may include a stop facility, an entry lane for freight handling, a multimodal transportation facility equipped with a freight transfer apparatus that transfers freight to the entry lane for freight handling, and a transportation management server that manages freight loading or unloading of a freight transfer object and controls freight transfer of the freight transfer apparatus.

The multimodal transportation facility may include a general entry lane which a general moving object enters.

The general entry lane and the entry lane for freight handling may be provided in a road zone.

The entry lane for freight handling may be provided closer to the stop facility than the general entry lane.

The entry lane for freight handling may be provided on a route where the at least one freight transfer object is moved.

The entry lane for freight handling may be provided at one side of an entrance or exit of the stop facility.

The at least one freight transfer object may include at least one of a moving object and an air vehicle.

The freight transfer apparatus may include a freight transfer element that is connected from the stop facility to the at least one entry lane for freight handling.

The freight transfer apparatus may further include a loading arm that transfers the freight, which is present on the freight transfer element, to the freight transfer object.

The freight transfer apparatus may include a freight transfer robot device that transfers the freight from at least one of the stop facility and the freight transfer element to the at least one freight transfer object.

The transportation management server may set at least one entry lane for freight handling among the plurality of entry lanes for freight handling and provide the set entry lane for freight handling to the freight transfer object.

The transportation management server may identify a condition of the plurality of entry lanes for freight handling and determine the at least one lane by considering the identified condition.

The transportation management server may identify a condition of the plurality of entry lanes for freight handling, provide the identified condition to a user of the freight transfer object and identify the at least one lane that is selected by the user.

The transportation management server may control opening or closing of a loading box provided in the at least one freight transfer object.

The transportation management server may transmit control information, which requests to open or close the loading box, to the at least one freight transfer object and receive a result of an open or closed state of the loading box from the at least one freight transfer object.

The transportation management server may request control for opening or closing of the loading box and control an open or closed state of the loading box in response to approval for the control for opening or closing of the loading box.

The transportation management server may identify the freight loading processing result and determine, by considering the processing result, an alternative freight transfer object that will be loaded with the freight.

According to another embodiment of the present disclosure, a freight transfer object capable of processing freight transfer may be provided. The freight transfer object may include a communication unit, at least one storage medium and at least one processor, and the at least one processor may be configured to determine freight to be loaded or unloaded based on freight information, which is provided by a transportation management server, to identify an entry lane for freight handling, which is to enter a multimodal transportation facility, and to process loading or unloading of the freight.

The at least one processor may be configured to provide freight transfer approval information to the transportation management server, when approaching the multimodal transportation facility.

The at least one processor may be configured to receive information including the entry lane for freight handling, which is determined by the transportation management server, and to determine the entry lane for freight handling based on the received information.

The at least one processor may be configured to receive information including a condition of the plurality of entry lanes for freight handling, to provide the received information and to identify the entry lane for freight handling based on a user input.

The at least one processor may be configured to receive information for controlling opening or closing of a loading box provided in the freight transfer object and to control the opening or closing of the loading box based on the information for controlling opening or closing of the loading box.

The at least one processor may be configured to indicate opening or closing of the loading box and to control the opening or closing of the loading box based on an input of a user.

The at least one processor may be configured to provide a result of an open or closed state of the loading box.

The at least one processor may provide control of the opening or closing of the loading box to the transportation management server.

The at least one processor may be configured to identify the freight loading processing result and to provide the freight loading processing result to the transportation management server.

According to another embodiment of the present disclosure, a transportation management server apparatus, which processes freight transport, may be provided in a multimodal transportation system. The transportation management server apparatus may include a communication unit, at least one storage medium and at least one processor, and the at least one processor may be configured to check and manage freight information for freight, which is handled through the multimodal transportation system, check a condition of a stop facility and a condition of an entry lane for freight handling, control freight loading or unloading of a freight transfer object, and control a freight transfer apparatus that transfers freight to the entry lane for freight handling.

The at least one processor may be configured to set at least one entry lane for freight handling among the plurality of entry lanes for freight handling and to provide the set entry lane for freight handling to the freight transfer object.

The at least one processor may be configured to identify a condition of the plurality of entry lanes for freight handling and to determine the at least one lane by considering the identified condition.

The at least one processor may be configured to identify a condition of the plurality of entry lanes for freight handling, to provide the identified condition to a user of the freight transfer object and to identify the at least one lane that is selected by the user.

The at least one processor may be configured to control opening or closing of a loading box provided in the at least one freight transfer object.

The at least one processor may be configured to transmit control information, which requests to open or close the loading box, to the at least one freight transfer object and to receive a result of an open or closed state of the loading box from the at least one freight transfer object.

The at least one processor may be configured to request control for opening or closing of the loading box and to control an open or closed state of the loading box in response to approval for the control for opening or closing of the loading box.

The at least one processor may identify the freight loading processing result.

The at least one processor may determine an alternative freight transfer object, which will be loaded with the freight, by considering the processing result.

According to another embodiment of the present disclosure, a transportation management server apparatus, which processes freight transport, may be provided in a multimodal transportation system. The apparatus may include a communication unit, at least one storage medium and at least one processor, and the at least one processor may be configured to provide freight information for freight, which is handled through the multimodal transportation system, identify freight that is to be transferred through at least one freight transfer object, and provide information on the identified freight.

The at least one processor may be configured to receive a freight transfer request message, which requests transfer of freight selected from a user terminal corresponding to the at least one freight transfer object, and to determine the at least one freight transfer object, which is to transfer the freight, based on the freight transfer request message.

The at least one processor may be configured to configure freight transfer approval information by including an identifier, which indicates the at least one freight transfer object that is to transfer the freight, and to provide the freight transfer approval information to a user terminal that corresponds to the at least one freight transfer object.

Embodiments of the present disclosure may provide a multimodal transportation system that is capable of effectively realizing freight loading or unloading by utilizing a multimodal transportation object in an environment of a take-off and landing facility, which is required for the operation of a next-generation mobility.

Also, embodiments of the present disclosure may provide a method and apparatus for loading or unloading freight quickly and effectively by utilizing a structure of a multimodal transportation system that is provided in a take-off and landing facility.

### BRIEF DESCRIPTION OF THE DRAWINGS

FIGS. 1A to 1C are views illustrating operation zones used in a multimodal transportation system according to an embodiment of the present disclosure.

FIG. 2A is a view illustrating the structure of a take-off and landing facility and an air vehicle operation zone, which are prepared in a multimodal transportation system, according to an embodiment of the present disclosure.

FIG. 2B is another view illustrating the structure of a take-off and landing facility and an air vehicle operation zone, which are prepared in a multimodal transportation system, according to an embodiment of the present disclosure.

FIG. 3A is a conceptual view showing schematically a configuration of a multimodal transportation system according to an embodiment of the present disclosure.

FIG. 3B is a view illustrating a structure of a multimodal transportation system according to an embodiment of the present disclosure.

FIGS. 4A to 4C illustrate a structure of a take-off and landing facility in a multimodal transportation system according to an embodiment of the present disclosure.

FIGS. 5A to 5E are views illustrating a detailed structure of a stop facility provided in a multimodal transportation system according to an embodiment of the present disclosure.

FIG. 6 is a view illustrating a detailed structure of a freight transfer apparatus provided in a multimodal transportation system according to another embodiment of the present disclosure.

FIG. 7 is a view illustrating a structure of a tollgate facility for freight handling to which a multimodal transportation system is applied according to another embodiment of the present disclosure.

FIG. 8 illustrate an operation of allocating freight in a multimodal transportation system according to an embodiment of the present disclosure.

FIGS. 9A to 9C illustrate an operation of processing freight transfer in a multimodal transportation system according to an embodiment of the present disclosure.

FIG. 10 is a block diagram illustrating a configuration of a local transportation management server provided in a multimodal transportation system according to an embodiment of the present disclosure.

FIG. 11 is a block diagram illustrating a configuration of a central transportation management server provided in a multimodal transportation system according to an embodiment of the present disclosure.

FIG. 12 is a view illustrating an apparatus configuration according to an embodiment of the present invention.

### DETAILED DESCRIPTION OF ILLUSTRATIVE EMBODIMENTS

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked”, “coupled”, or “connected” to another component, it is understood that not only a direct connection relationship but also an indirect connection relationship through an intermediate component may also be included. Also, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc. unless specifically stated otherwise. Thus, within the scope of this disclosure, a first component in one exemplary embodiment may be referred to as a second component in another embodiment, and similarly a second component in one exemplary embodiment may be referred to as a first component in another embodiment.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various exemplary embodiments are not necessarily essential components, and some may be optional components. Accordingly, exemplary embodiments consisting of a subset of the components described in one embodiment are also included within the scope of the present disclosure. Also, exemplary embodiments that include other components in addition to the components described in the various embodiments are also included in the scope of the present disclosure.

Advantages and features of embodiments of the present disclosure, and methods for achieving them will be apparent with reference to the exemplary embodiments described below in detail with reference to the accompanying drawings. However, the present disclosure is not limited to the exemplary embodiments set forth herein but may be embodied in many different forms. The present exemplary embodiments are provided to make disclosed contents of the present disclosure thorough and complete and to completely convey the scope of the disclosure to those with ordinary skill in the art.

Although exemplary embodiments may be described as using a plurality of units to perform the exemplary processes, it is understood that the exemplary process may also be performed by one or a plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

An aerial vehicle control system according to an embodiment of the present disclosure may include a system for controlling next-generation aerial mobilities such as an urban air mobility (UAM) and a personal air vehicle (PAV). When a configuration or operation of an aerial vehicle control system is described according to an embodiment of the present disclosure, a personal aerial vehicle is used, but the present disclosure does not limit next-generation aerial mobilities to personal aerial vehicles, and various next-generation mobilities may be used.

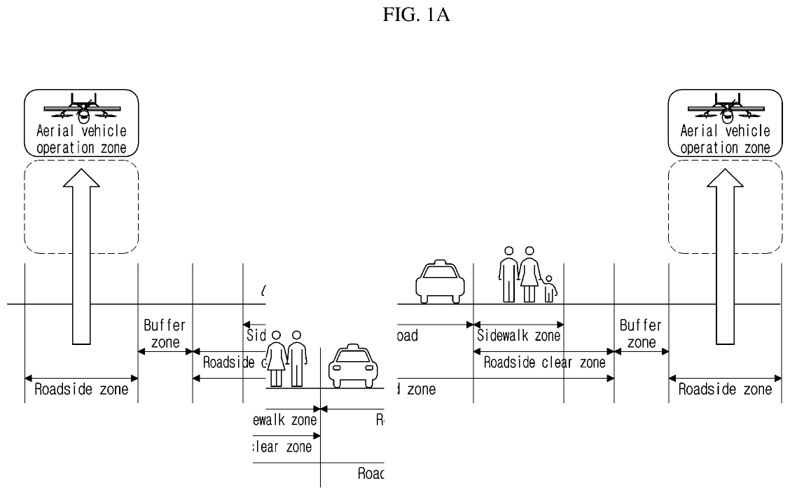

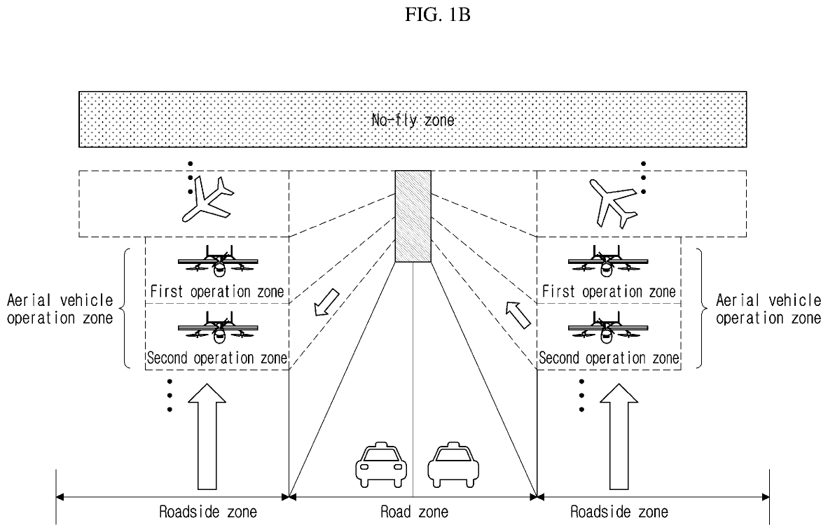

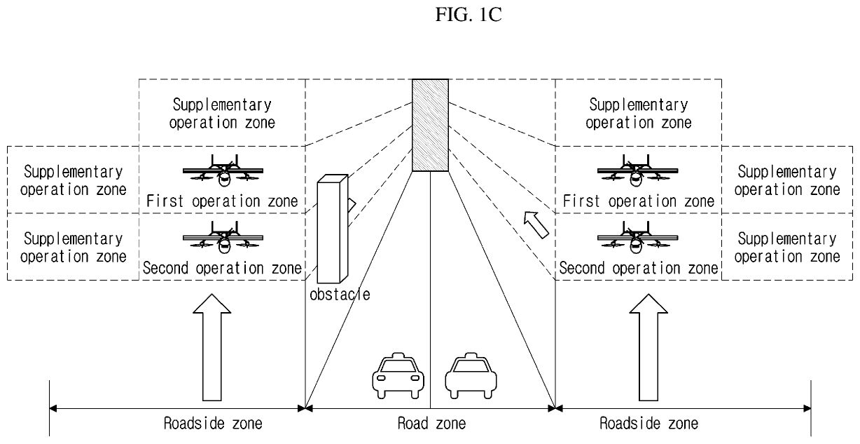

FIGS. 1A to 1C are views illustrating operation zones for an aerial vehicle used in an aerial vehicle control system according to an embodiment of the present disclosure.

In an embodiment of the present disclosure, an aerial vehicle control system may control movement of an aerial vehicle, particularly to enable the aerial vehicle to move in an aerial vehicle operation zone.

First, referring to FIG. 1A, an aerial vehicle operation zone may be set based on a road zone in which a moving object is operated. Herein, the road zone may be a zone on the ground in which a road is set. Herein, the road may include a driveway, in which a moving object is moved, and a sidewalk zone in which people move. As another example, a road zone may include a road zone and a roadside clear zone, which are set according to a road act.

As an example, an aerial vehicle operation zone may be set as a zone at a predetermined height or higher above a road zone. Furthermore, in case a personal aerial vehicle has an abnormality and lands or crashes while operating in an aerial vehicle operation zone set above a road zone, a moving object (or a person) moving in the road zone may be affected. Accordingly, it is desirable that an aerial vehicle operation zone is set vertically above a neighboring zone of a road zone (hereinafter, referred to as “roadside zone”), instead of vertically above the road zone. For example, it is desirable that a preset distance range from a road zone is set as a roadside zone and an aerial vehicle operation zone is set above the roadside zone. Furthermore, a predetermined buffer zone may be set between the road zone and the roadside zone.

Referring to FIG. 1B, an aerial vehicle operation zone may include a plurality of operation zones that are distinguished in a vertical direction. For example, an aerial vehicle operation zone may include a first operation zone and a second operation zone, and the first operation zone may be managed as a higher course than the second operation zone. In addition, a first operation zone may be set and managed as a relatively higher zone than a second operation zone. Accordingly, an aerial vehicle control system may control an aerial vehicle moving at relatively high speed to move in the first operation zone and control an aerial vehicle moving at relatively low speed to move in the second operation zone. As another example, an aerial vehicle control system may manage a second operation zone as a slow lane and a first operation zone as a fast lane.

As yet another example, a type of an aerial vehicle may be set according to size or purpose of use, and a type of an aerial vehicle capable of operating in a plurality of operation zones may be set and managed. As an example, according to purpose of use, aerial vehicles may be classified into passenger aerial vehicles and cargo aerial vehicles. Accordingly, an aerial vehicle control system may control a passenger aerial vehicle to move in the first operation zone and control a cargo aerial vehicle to move in the second operation zone. As another example, according to size, aerial vehicles may be classified into small aerial vehicles, mid-sized aerial vehicles and large aerial vehicles. Correspondingly, an aerial vehicle control system may control an aerial vehicle with relatively large size to operate in a higher course. As an example, an aerial vehicle control system may control a large aerial vehicle to move in the first operation zone and control a small aerial vehicle or a mid-sized aerial vehicle to move in the second operation zone. As yet another example, an aerial vehicle operation zone may include a first operation zone, a second operation zone and a third operation zone, and an aerial vehicle control system may control a large aerial vehicle to move in the first operation zone, a mid-sized aerial vehicle to move in the second operation zone and a small aerial vehicle to move in the third operation zone.

In an embodiment of the present disclosure, a first operation zone, a second operation zone and a third operation zone are described as multiple operation zones, but the present disclosure is not limited thereto, and the number of operation zones may vary.

Referring to FIG. 1C, in an embodiment of the present disclosure, an aerial vehicle operation zone may include a supplementary operation zone capable of expanding an operation zone either vertically or horizontally. For example, there may be an obstacle at a certain point or in a section of an aerial vehicle operation zone, thus a supplementary operation zone may be set to drive by evading the obstacle. As an example, a supplementary operation zone may be configured by expanding an operation zone in vertical direction. As another example, one of 8 directions from an operation path of an aerial vehicle may be set as a supplementary operation zone.

Furthermore, a supplementary operation zone may be configured adaptively according to a type of an obstacle. For example, in case there is a fixed obstacle, an aerial vehicle control system may set a supplementary operation zone in a corresponding section so that an aerial vehicle operation zone may be managed by being temporarily expanded. As another example, in case a movable obstacle is identified, an aerial vehicle control system may identify a movement direction and speed of the movable obstacle and set a supplementary operation zone by selecting one of 8 directions from an operation course of an aerial vehicle as an optimal evasion zone.

As an example, an aerial vehicle operation zone may be set based on a predetermined altitude. As another example, an aerial vehicle operation zone may change its altitude adaptively according to weather information. For example, weather information may include information for identifying weather conditions like snowfall, rainfall, fog and the like, and an altitude range of an aerial vehicle operation zone may be set based on such weather information. An altitude range of an aerial vehicle operation zone may be set in predetermined distance units (e.g., 300 m, 500 m, and 1 km).

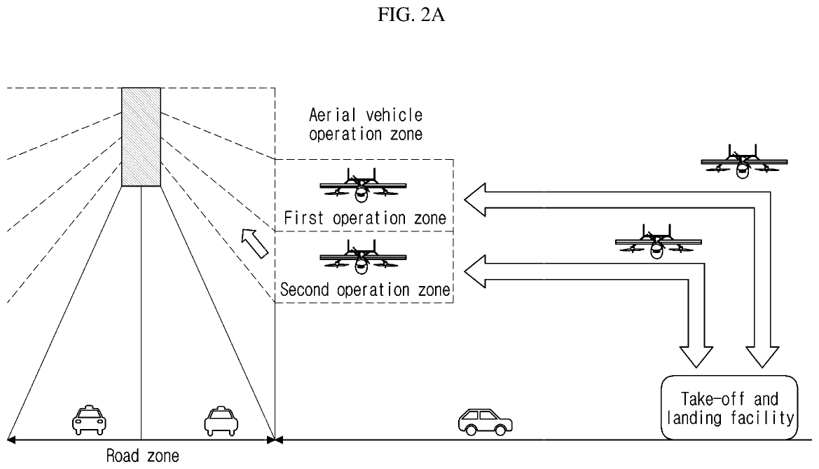

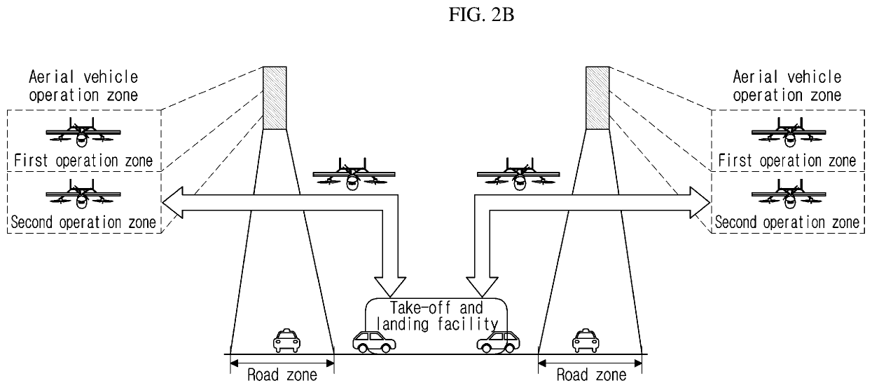

Meanwhile, referring to FIG. 2A, an aerial vehicle may enter an aerial vehicle operation zone restrictedly through a take-off and landing facility. Herein, the take-off and landing facility may include a space, in which an aerial vehicle may take off or land, and a controller capable of controlling entry into and exit from an aerial vehicle operation zone. As an example, the take-off and landing facility may include an expressway tollgate facility, a service facility and the like. Furthermore, it is desirable that the take-off and landing facility is installed at one side or both sides of a road zone.

As another example, referring to FIG. 2B, a road zone may have a northbound lane and a southbound lane separate from each other, and an expressway tollgate facility, a service facility and the like may be installed in the central areas of the northbound lane and the southbound lane respectively. Thus, a take-off and landing facility may be located in the central area of a road zone.

Furthermore, a take-off and landing facility may be connected with a control server that performs control of take-off and landing of an aerial vehicle, control of entry into and exit from an aerial vehicle operation zone, and information exchange with an aerial vehicle. A control server may include a local control server and a central control server. A local control server may include a server that is provided within a take-off and landing facility or adjacent to the take-off and landing facility. In addition, a central control server may include a server that is connected with at least one local control server and performs overall control of an aerial vehicle control system.

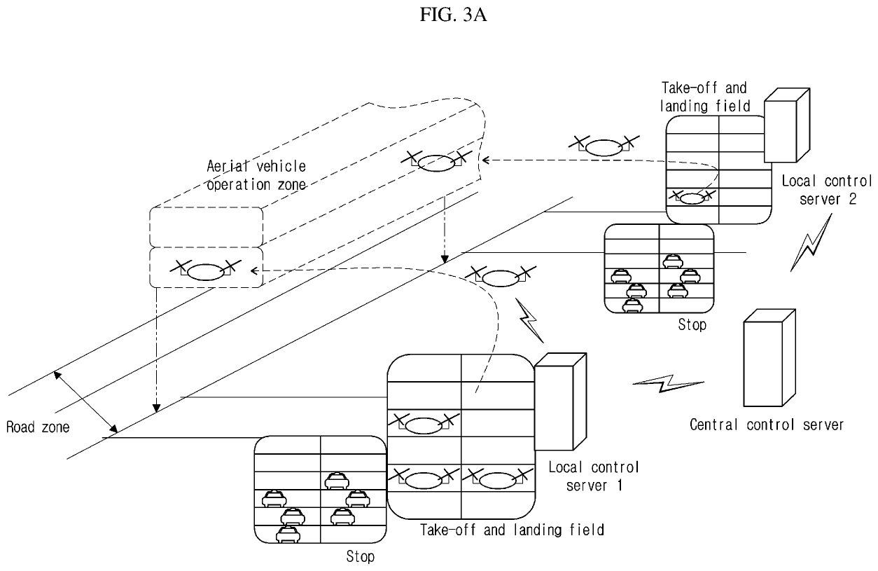

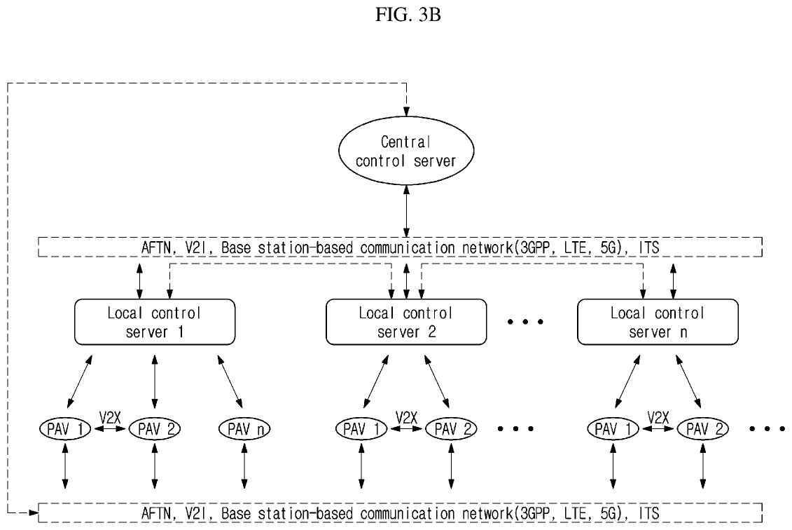

FIG. 3A is a conceptual view showing schematically a configuration of an aerial vehicle control system according to an embodiment of the present disclosure, and FIG. 3B is a view illustrating a structure of an aerial vehicle control system according to an embodiment of the present disclosure.

Referring to FIG. 3A, a take-off and landing facility and an aerial vehicle operation zone may be set, and an aerial vehicle control system may control the movement or operation of a personal aerial vehicle in the take-off and landing facility and the aerial vehicle operation zone.

A take-off and landing facility may include a stop, in which a personal aerial vehicle or a moving object may stop, and a take-off and landing field in which a personal aerial vehicle may take off and land. Herein, the stop and the take-off and landing field may be set as different areas on a single plane. As another example, a take-off and landing facility may include a building constructed with a plurality of floors, and a stop and a take-off and landing field may be set on different floors. As yet another example, a stop may be configured to separate areas in which a personal aerial vehicle or a moving object may stop. For example, a stop may include a first stop, where a personal aerial vehicle stands, and a second stop where a moving object stops. A first stop and a second stop may be set as different areas on a single plane or as different floors. As yet another example, a first stop and a take-off and landing field may be set as different areas on a single plane, and a second stop may be set as a different floor from the first stop and the take-off and landing field.

For example, a personal aerial vehicle may be available in a road zone, a stop, a take-off and landing field, and an aerial vehicle operation zone and may include a moving object with a shape capable of vertical take-off and landing (e.g., vertical take-off and landing (VTOL) and electric vertical take-off and landing (e-VTOL)). Accordingly, a personal aerial vehicle may move from a road zone to a stop, a take-off and landing field, and the like and move from the take-off and landing field to an aerial vehicle operation zone under the control of a control server (local control server or central control server). In addition, under the control of a control server (local control server or central control server), a personal aerial vehicle may move from an aerial vehicle operation zone to a take-off and landing field.

Furthermore, in an embodiment of the present disclosure, a section in which a personal aerial vehicle is moved from a take-off and landing field to an aerial vehicle operation zone is called an entry section, and a section in which the personal aerial vehicle is moved from the aerial vehicle operation zone to the take-off and landing field is called an exit section.

Meanwhile, a central control server may be connected with a local control server via a communication network and receive information on a personal aerial vehicle from the local control server. In addition, the central control server may provide the local control server with information necessary to control a personal aerial vehicle or to control an entry section or an exit section. In addition, the central control server may provide operation information necessary for a personal aerial vehicle to operate in an aerial vehicle operation zone. Meanwhile, although a personal aerial vehicle may freely move in a take-off and landing field, an entry section, an exit section and an aerial vehicle operation zone, as personal aerial vehicles move at relatively high speed, an accident is very likely to happen in the take-off and landing field, the entry section and the exit section. Accordingly, it is necessary to set control rights for movement or operation by distinguishing a local control server, a central control server, a personal aerial vehicle and the like according to a location or situation of the personal aerial vehicle.

Referring to FIG. 3B, an aerial vehicle control system according to an embodiment of the present disclosure may include a local control server, a central control server, and a personal aerial vehicle, and the local control server, the central control server, and the personal aerial vehicle may exchange information necessary for control via communication. Also, a personal aerial vehicle may control movement or operation based on information received from a local control server and a central control server.

A personal aerial vehicle and a local control server may be connected with each other based on a vehicle to everything (V2X) communication scheme, and the personal aerial vehicle and a central control server may be connected with each other based on a vehicle to everything (V2X) communication scheme. As an example, it is desirable that a personal aerial vehicle and a local control server are connected to each other through a vehicle to infrastructure (V2I) scheme and the personal aerial vehicle and a central control server are connected to each other through a V2I scheme. A personal aerial vehicle and a local control server may be connected with each other via an aeronautical telecommunication network (AFTN), and the personal aerial vehicle and a central control server may be connected with each other via an AFTN.

As yet another example, a personal aerial vehicle and a local control server may be connected with each other via a base station-based communication network, and the personal aerial vehicle and a central control server may be connected with each other via a base station-based communication network. As an example, a base station-based communication network may include a cellular communication network, a communication network based on 3rd generation partnership project (3GPP), a communication network based on long term evolution (LTE), and a communication network based on fifth generation (5G) technology standard. Although, in an embodiment of the present disclosure, a communication network based on 3rd generation partnership project (3GPP), a communication network based on long term evolution (LTE), and a communication network based on fifth generation (5G) technology standard are described as examples of base station-based communications, but the present disclosure is not limited thereto, and various types of cellular communication networks may be used.

Furthermore, an aerial vehicle control system according to an embodiment of the present disclosure may configure different communication networks connecting a local control server or a central control server according to a location of a personal aerial vehicle. As an example, in case a personal aerial vehicle exists within a take-off and landing facility or exists in an entry section or an exit section, the personal aerial vehicle may be connected with a local control server based on an X2V scheme. In addition, in case the personal aerial vehicle exists in an aerial vehicle operation zone, the personal aerial vehicle may be connected with the central control server (or local control server) via an AFTN or cellular communication network.

In addition, a personal aerial vehicle may be connected with another personal aerial vehicle through a V2X scheme. Thus, a personal aerial vehicle may be connected with another neighboring personal aerial vehicle through a V2X scheme, and a distance between neighboring personal aerial vehicles may be measured so that a collision between personal aerial vehicles may be prevented.

Basically, a central control server may set an operation condition in an aerial vehicle control system such as an entry section, an exit section, an aerial vehicle operation zone and the like and set and provide a control parameter matching the operation condition to a local control server or a personal aerial vehicle. Herein, the operation condition may include a speed, an interval, a set altitude of an aerial vehicle operation zone and the like.

Furthermore, a central control server may check and store a weather condition necessary to set an operation condition. To this end, the central control server may be connected with a device (or server) capable of providing weather information via a communication network and receive and store weather information periodically. As another example, the central control server may receive and store weather information from a device (or server) capable of providing weather information whenever a preset condition (e.g., lightning, gale, storm, heavy rainfall) is satisfied.

Also, a central control server may manage operation information of a personal aerial vehicle operated within an aerial vehicle control system and identify and manage a degree of congestion of each section of an aerial vehicle operation zone based on the operation information.

Also, a central control server may identify and manage event information (e.g., accident, obstacle, emergency situation) occurring within an aerial vehicle operation zone.

Also, a central control server may perform network linkage between local control servers, management of situations in a take-off and landing facility connected to a local control server, and the like.

Meanwhile, a local control server may manage the control right of a personal aerial vehicle in an entry section, an exit section and an aerial vehicle operation zone. As an example, a local control server may set the control right of a personal aerial vehicle to a local control server or to a personal aerial vehicle. To this end, a local control server may receive information required to set the control right of a personal aerial vehicle from the personal aerial vehicle and set and manage the control right for the personal aerial vehicle based on the received information.

Also, a local control server may identify and manage a condition of a stop, a condition of a take-off and landing field, and the like. For example, the condition of a stop may include an occupancy state of a spot included in the stop, an identifier of a moving object or a personal aerial vehicle present at the occupied spot, and the like. Likewise, the condition of a take-off and landing field may include an occupancy state of a spot included in the take-off and landing field, an identifier of a personal aerial vehicle present at the occupied spot, and the like. Furthermore, a local control server may identify and manage a degree of congestion in a take-off and landing facility based on a condition of a stop, a condition of a take-off and landing field, and the like.

Furthermore, a local control server may check and store the above-described weather condition. As an example, a local control server may receive and store weather information from a central control server. As another example, a local control server may be connected with a device (or server) capable of providing weather information via a communication network and receive and store weather information periodically. Also, a local control server may store and manage operation conditions like an entry section, an exit section, and an aerial vehicle operation zone. An operation condition may be received from a central control server and be managed.

Also, a local control server may identify and manage event information (e.g., accident, obstacle, emergency situation) occurring within an aerial vehicle operation zone. Event information may be received from a central control server or be generated based on a degree of congestion of a take-off and landing facility, weather information and the like.

Meanwhile, like a conventional personal aerial vehicle, a personal aerial vehicle may be controlled to move in a predetermined airspace, and the movement may be controlled through a user's operation control or autonomous driving control. Particularly, the movement or operation of a personal aerial vehicle may be controlled in a take-off and landing field, an entry section, an exit section, and an aerial vehicle operation zone, and the movement or operation may be controlled based on information received from a local control server or a central control server. Furthermore, the control right of a personal aerial vehicle may be determined according to a zone that is set in an aerial vehicle control system, and movement or operation may be controlled in response to the determined control right.

A multimodal transportation system based on a personal air vehicle (hereinafter, referred to as ‘multimodal transportation system’) according to an embodiment of the present disclosure may be a system that transfers freight by using a take-off and landing facility, where a personal air vehicle takes off and lands, as a logistics hub. Basically, a multimodal transportation system may include an environment in which the departure point and destination of freight may be identified and freight may be transferred from the departure point to the destination. In addition, a multimodal transportation system may include an environment in which freight may be transferred from a departure point to a destination especially by a personal air vehicle. As an example, a multimodal transportation system may be configured to perform and manage freight delivery between personal air vehicles, freight delivery between a personal air vehicle and a moving object, and freight delivery between moving objects.

For this, a take-off and landing facility provided in a multimodal transportation system may include a logistics processing unit capable of delivering freight to a personal air vehicle or a moving object. Also, a multimodal transportation system may include a transportation management server that is capable of managing a departure point or a destination of freight, determining a personal air vehicle or a moving object to be loaded with freight, and processing the transfer management of freight by a logistics processing unit. A central transportation management server and a local transportation management server may execute operations of a central control server and a local control server respectively. Furthermore, a transportation management server may include a central transportation management server, which performs overall management of freight transfer, and a local transportation management server corresponding to each take-off and landing facility.

Hereinafter, a detailed structure of a take-off and landing facility, an operation of a central transportation management server, an operation of a local transportation management server and the like will be described in detail.

Depending on a purpose of operation, personal air vehicles and moving objects may be classified into general personal air vehicles and general moving objects, which are used for a general purpose, and freight transfer air vehicles and freight transfer moving objects, which are intended for freight transportation by a multimodal transportation system according to an embodiment of the present disclosure.

As an example, a general personal air vehicle and a freight transfer air vehicle may be physically the same, and the freight transfer air vehicle may be an air vehicle that transfers freight which is allocated by a multimodal transportation system according to an embodiment of the present disclosure. As another example, a freight transfer air vehicle is an air vehicle, which is embodied for the purpose of freight transfer, and may be configured differently from a general personal air vehicle. Likewise, a general moving object and a freight transfer moving object may be physically the same, and the freight transfer moving object may be a moving object that transfers freight which is allocated by a multimodal transportation system according to an embodiment of the present disclosure. As another example, a freight transfer moving object is a moving object, which is embodied for the purpose of freight transfer, and may be configured differently from a general moving object.

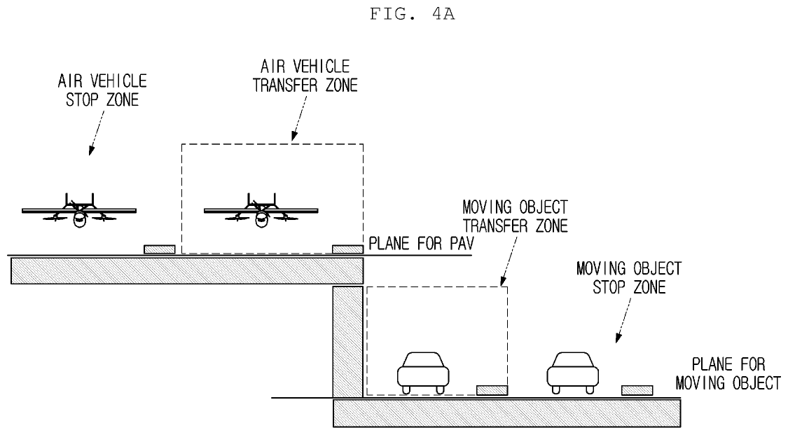

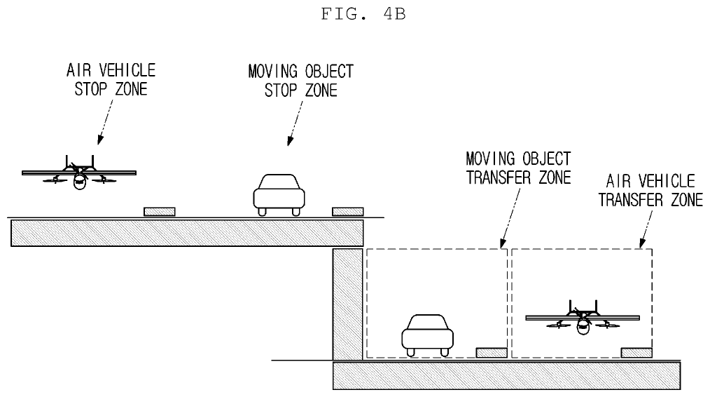

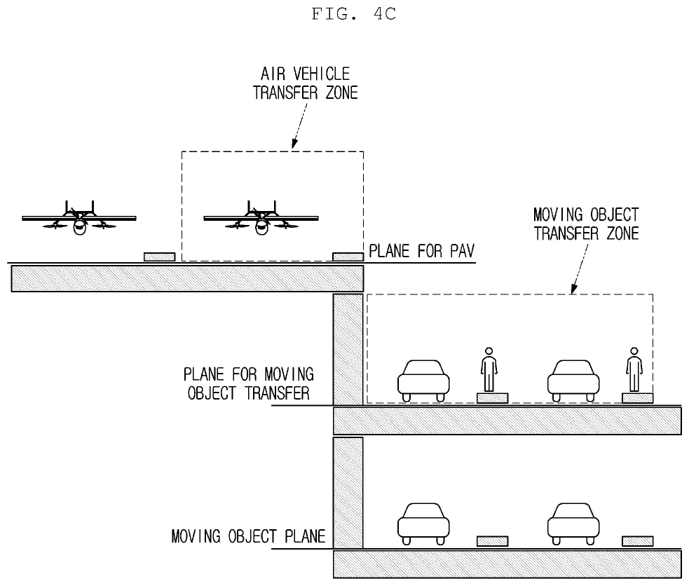

FIGS. 4A to 4C illustrate a structure of a take-off and landing facility in a multimodal transportation system according to an embodiment of the present disclosure.

First, as described above, a take-off and landing facility in a multimodal transportation system according to an embodiment of the present disclosure may include a stop and a take-off and landing pad, and the stop in particular may include a zone in which a freight transfer air vehicle may stop (hereinafter, referred to as ‘freight transfer air vehicle stop zone’), and a zone in which a freight transfer moving object may stop (hereinafter, referred to as ‘freight transfer moving object zone’). Also, the stop may further include a freight standby zone in which freight may be temporarily loaded and stored. As an example, a freight transfer air vehicle stop zone and a freight transfer moving object stop zone may be provided on a same plane. As another example, a take-off and landing facility may consist of a plurality of floors, and a freight transfer air vehicle stop zone, a freight transfer moving object stop zone, or a freight standby zone may be provided on different floors.

Furthermore, a stop may include a zone in which a general air vehicle may stop (hereinafter, referred to as ‘general PAV stop zone’), and a zone in which a general moving object may stop (hereinafter, referred to as ‘general moving object stop zone’).

A general PAV stop zone and a general moving object stop zone may be in an area different from an area for a freight transfer air vehicle stop zone and a freight transfer moving object stop zone. As an example, a general PAV stop zone and a freight transfer air vehicle stop zone may be on a same plane, and a general moving object stop zone and a freight transfer moving object stop zone may be provided on different planes. For example, a general PAV stop zone and a freight transfer air vehicle stop zone may be in an area with open overhead space (e.g., rooftop of a building or open space on the ground), and a general moving object stop zone and a freight transfer moving object stop zone may be in a space under the general PAV stop zone and the freight transfer air vehicle stop zone (e.g., in a building or in an underground space). As another example, a freight transfer air vehicle stop zone and a freight transfer moving object stop zone may be in an area with open overhead space (e.g., rooftop of a building or open space on the ground), and a general PAV stop zone and a general moving object stop zone may be in a space under the freight transfer air vehicle stop zone and the freight transfer moving object stop zone (e.g., in a building or in an underground space).

Although, in an embodiment of the present disclosure, a freight transfer air vehicle stop zone, a freight transfer moving object stop zone, a general PAV stop zone, a general moving object stop zone and a freight standby zone are exemplified with respect to their structures, the present disclosure is not limited thereto, and the structures may be modified and applied in various ways by those skilled in the art.

Meanwhile, a take-off and landing facility may include an apparatus that is capable of transferring freight among a freight transfer air vehicle stop zone, a freight transfer moving object stop zone, or a freight standby zone. Herein, the apparatus capable of transferring freight may include a conveyor belt, a cargo-carrying robot device, and the like. Furthermore, an apparatus capable of transferring freight may be connected with a local transportation management server (or central transportation management server) via a communication network and transfer freight, based on information provided from the local transportation management server (or central transportation management server), between freight transfer air vehicles, between freight transfer moving objects, or between a freight transfer air vehicle and a freight transfer moving object. As an example, as a freight transfer air vehicle stops in a freight transfer air vehicle zone, the freight transfer air vehicle may request movement of freight, which is loaded in the air vehicle, to a local transportation management server, and the local transportation management server may check, through a central transportation management server, information on the freight (hereinafter, referred to as ‘freight information’), for which the movement is requested, and a zone to which the freight may be moved. Accordingly, the apparatus capable of transferring freight may transfer freight to a corresponding zone. Herein, the corresponding zone may include a zone in which a freight transfer air vehicle stops, a zone in which a freight transfer moving object stops, and the like. As another example, the corresponding zone may include a freight standby zone.

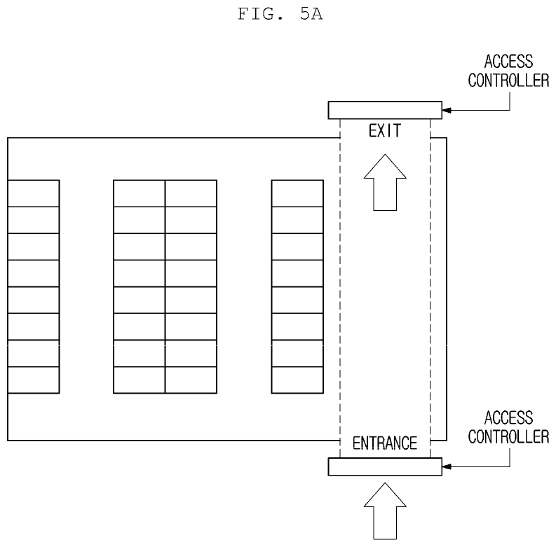

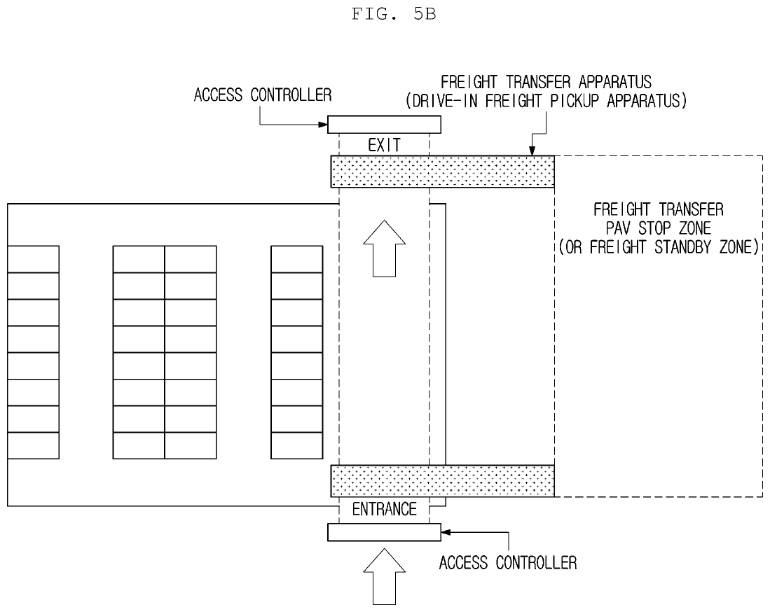

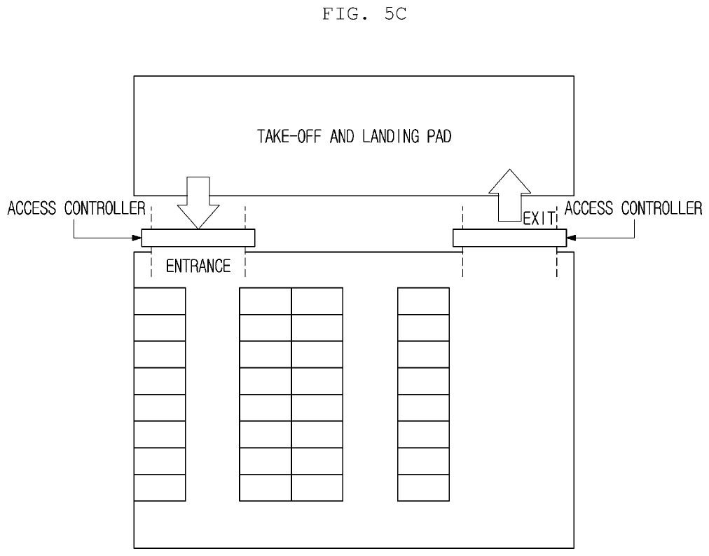

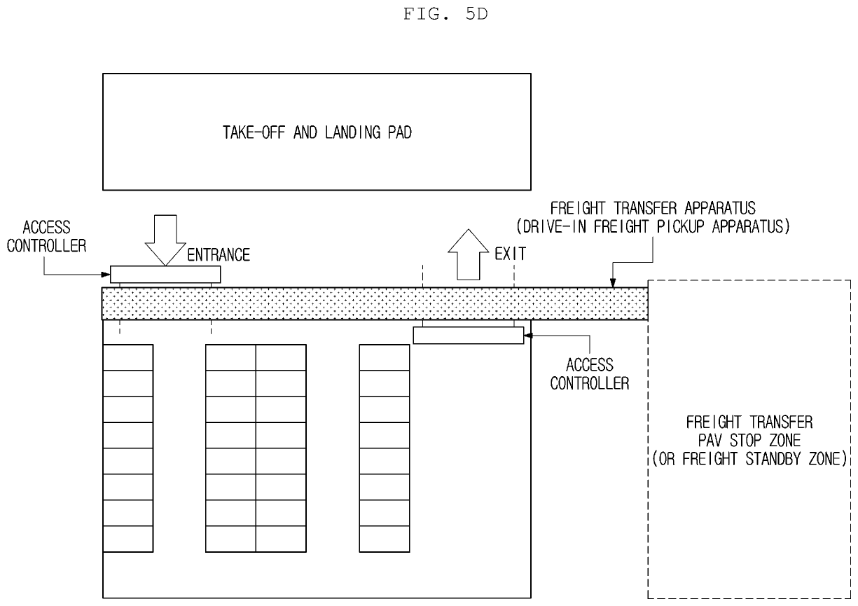

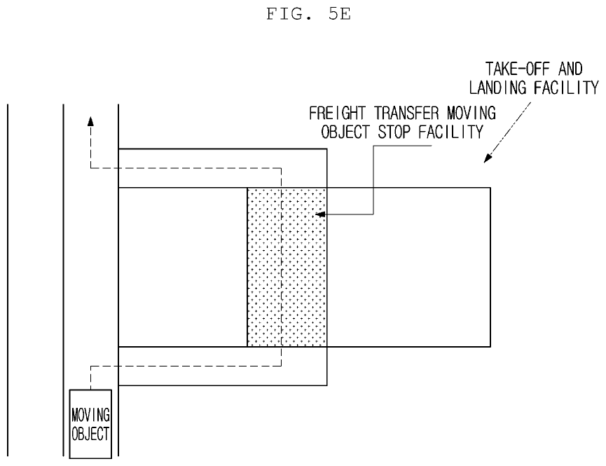

FIGS. 5A to 5E are views illustrating a detailed structure of a stop facility to which a multimodal transportation system according to an embodiment of the present disclosure is applied.

Specifically, FIG. 5A illustrates a detailed structure of a general moving object stop facility, FIG. 5B illustrates a detailed structure of a freight transfer moving object stop facility, FIG. 5C illustrates a detailed structure of a general air vehicle stop facility, and FIG. 5D illustrates a detailed structure of a freight transfer air vehicle stop facility. Herein, a general moving object stop facility, a freight transfer moving object stop facility, a general air vehicle stop facility, and a freight transfer air vehicle stop facility may include a general moving object stop zone, a freight transfer moving object stop zone, a general air vehicle stop zone, and a freight transfer air vehicle stop zone, respectively.

Referring to FIG. 5A, a general moving object stop facility is a facility which is constructed based on the general moving object stop zone described above, and may include at least one parking/stopping lot. The at least one parking/stopping lot may be a facility in which a moving object stops or is parked.

A general moving object stop facility may need to check and manage a moving object that enters or exits from at least one parking/stopping lot. Considering this, the general moving object stop facility may include an access controller capable of identifying a moving object, which enters or exits from the facility, and of controlling entry or exit of the moving object. The access controller may be connected with the above-described local transportation management server via a communication network, and its operation may be controlled by the local transportation management server.

Referring to FIG. 5B, a freight transfer moving object stop facility is a facility which is constructed based on the freight transfer moving object stop zone described above, and may include at least one parking/stopping lot. The at least one parking/stopping lot may be a facility in which a moving object stops or is parked.

A freight transfer moving object stop facility may need to check and manage a moving object that enters or exits from at least one parking/stopping lot. Considering this, the freight transfer moving object stop facility may include an access controller capable of identifying a moving object which enters or exits from the facility, and of controlling entry or exit of the moving object. The access controller may be connected with the above-described local transportation management server via a communication network, and its operation may be controlled by the local transportation management server.

In particular, a freight transfer moving object stop facility may include a freight transfer apparatus. A freight transfer apparatus may be an apparatus capable of processing freight transfer between a freight transfer moving object stop facility and a freight transfer air vehicle stop facility (or freight standby facility) and be connected with the above-described local transportation management server via a communication network. Its operation may be controlled by the local transportation management server. A freight transfer apparatus may be provided at the entrance or exit of a freight transfer moving object stop facility. A freight transfer apparatus installed at the entrance of a freight transfer moving object stop facility may include a facility capable of unloading freight from a moving object that enters a freight transfer moving object stop facility. In addition, a freight transfer apparatus installed at the exit of a freight transfer moving object stop facility may include a facility capable of loading freight allocated to a moving object that exits from a freight transfer moving object stop facility.

Furthermore, a local transportation management server may be configured to control a loading box of a freight transfer moving object through communication with the freight transfer moving object. For example, as a freight transfer moving object enters at the entrance of a freight transfer moving object stop facility, the local transportation management server may retrieve control temporarily of the freight transfer moving object and may control a loading box of the moving object to switch to an open state. Next, the local transportation management server may notify to a freight transfer apparatus that the loading box of the freight transfer moving object is switched to the open state, and the freight transfer apparatus may identify freight to be unloaded and unload the freight from the moving object and transfer the unloaded freight to a freight transfer air vehicle stop facility (or freight standby facility).

Referring to FIG. 5C, a general air vehicle stop facility is a facility which is constructed based on the general air vehicle stop zone described above, and may include at least one parking/stopping lot. The at least one parking/stopping lot may be a facility in which an air vehicle stops or is parked.

A general air vehicle stop facility may need to check and manage an air vehicle that enters or exits from at least one parking/stopping lot. Considering this, the general air vehicle stop facility may include an access controller capable of identifying an air vehicle, which enters or exits from the facility, and of controlling entry or exit of the air vehicle. The access controller may be connected with the above-described local transportation management server via a communication network, and its operation may be controlled by the local transportation management server.

Referring to FIG. 5D, a freight transfer air vehicle stop facility is a facility which is constructed based on the freight transfer air vehicle stop zone described above, and may include at least one parking/stopping lot. The at least one parking/stopping lot may be a facility in which an air vehicle stops or is parked.

A freight transfer air vehicle stop facility may need to check and manage an air vehicle that enters or exits from at least one parking/stopping lot. Considering this, the freight transfer air vehicle stop facility may include an access controller capable of identifying an air vehicle which enters or exits from the facility, and of controlling entry or exit of the air vehicle. The access controller may be connected with the above-described local transportation management server via a communication network, and its operation may be controlled by the local transportation management server.

In particular, a freight transfer air vehicle stop facility may include a freight transfer apparatus. A freight transfer apparatus may be an apparatus capable of processing freight transfer between a freight transfer moving object stop facility and a freight transfer air vehicle stop facility (or freight standby facility) and be connected with the above-described local transportation management server via a communication network. Its operation may be controlled by the local transportation management server. A freight transfer apparatus may be provided at the entrance or exit of a freight transfer air vehicle stop facility. A freight transfer apparatus installed at the entrance of a freight transfer air vehicle stop facility may include a facility capable of unloading freight from an air vehicle that enters a freight transfer air vehicle stop facility. In addition, a freight transfer apparatus installed at the exit of a freight transfer air vehicle stop facility may include a facility capable of loading freight allocated to an air vehicle that exits from a freight transfer air vehicle stop facility.

Furthermore, a local transportation management server may be configured to control a loading box of a freight transfer air vehicle through communication with the freight transfer air vehicle. For example, as a freight transfer air vehicle enters at the entrance of a freight transfer air vehicle stop facility, the local transportation management server may retrieve control temporarily of the freight transfer air vehicle and may control a loading box of the air vehicle to switch to an open state. Next, the local transportation management server may notify to a freight transfer apparatus that the loading box of the freight transfer air vehicle is switched to the open state, and the freight transfer apparatus may identify freight to be unloaded and unload the freight from the air vehicle and transfer the unloaded freight to a freight transfer air vehicle stop facility (or freight standby facility).

A freight transfer apparatus installed at the entrance of a freight transfer moving object stop facility may include a facility capable of unloading freight from a moving object that enters a freight transfer moving object stop facility.

Although, in an embodiment of the present disclosure, a freight transfer moving object is exemplified to enter and stop at a stop facility, which is provided in a multimodal transportation facility, the freight transfer moving object is not limited by the present embodiment but may be modified in various ways. As another example, a freight transfer moving object may perform loading or unloading of freight without stopping at a multimodal transportation facility. Considering this, as exemplified in FIG. 5E, a freight transfer moving object stop facility may be configured to enable a freight transfer moving object to stop temporarily on a route and to perform loading or unloading of freight.

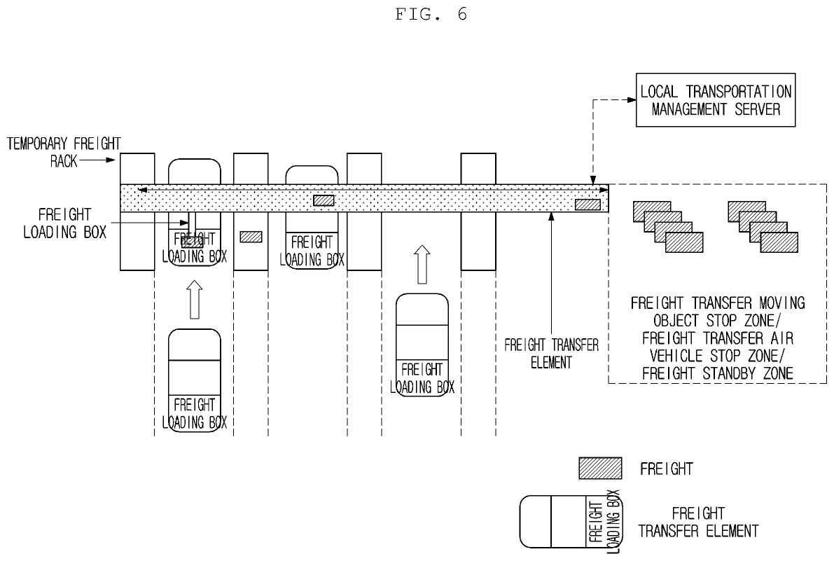

FIG. 6 is a view illustrating a detailed structure of a freight transfer apparatus provided in a multimodal transportation system according to another embodiment of the present disclosure.

First, the freight transfer apparatus exemplified in FIG. 6 is provided in a freight transfer moving object stop facility but is not limited by the present embodiment and may be modified in various ways.

Referring to FIG. 6, a freight transfer apparatus is basically provided to transfer freight between a freight transfer moving object stop facility and a freight transfer air vehicle stop facility (or freight standby facility). As an example, a freight transfer apparatus may be provided on a route, along which a freight transfer moving object moves, in order to minimize a time required for loading or unloading freight from a freight transfer moving object.

Specifically, a freight transfer apparatus may include a freight transfer element capable of transferring freight between a freight transfer moving object stop facility and a freight transfer air vehicle stop facility (or freight standby facility). The freight transfer element may be connected up to a freight transfer air vehicle stop facility (or freight standby facility) and be connected up to an area contacting a freight transfer moving object stop facility.

As an example, a freight transfer moving object stop facility may be equipped with a plurality of entry lanes, which enable a plurality of freight transfer moving objects to enter at the same time, in order to efficiently process freight loading or unloading, and a freight transfer element may be provided in a form that transverses the plurality of entry lanes. For example, the freight transfer element may be provided three-dimensionally over or under the entry lanes.

A freight transfer apparatus may include a temporary freight rack that is provided more or less perpendicular to a freight transferring direction of a freight transfer element. The temporary freight rack may be provided close to an entry lane. The freight transfer apparatus may include a device (e.g., sensor) capable of detecting the entry of a moving object or an air vehicle (hereinafter, referred to as ‘entry detection device’), and the entry detection device may detect and provide the entry of a moving object or an air vehicle to a local transportation management server. Also, the freight transfer apparatus may control the freight transfer element so that freight to be loaded on a freight transfer moving object may be delivered to the temporary freight rack at the entry time of the freight transfer moving object. Thus, a user may load the freight transfer moving object with the freight that is temporarily put in the temporary freight rack. Herein, the user may include a driver or a passenger.

Furthermore, the freight transfer apparatus may include a device (e.g., sensor) capable of detecting whether or not loading of freight is completed (hereinafter, referred to as ‘loading detection device’). In addition, the freight transfer apparatus may provide information, which is provided by the loading detection device, to a local transportation management server. In addition, the local transportation management server may provide information regarding whether or not freight is loaded to a user terminal or a moving object based on information provided from the loading detection device. Furthermore, the local transportation management server may provide information regarding whether or not freight is loaded to a user, who requests freight loading, through a central transportation management server.

As an example, the freight transfer apparatus may further include a freight loading arm, which is connected to a freight transfer element, and control the freight loading arm to load a freight transfer moving object with freight from the freight transfer element or a temporary freight rack. In this case, as the freight transfer moving object enters a freight transfer moving object stop facility, the freight transfer moving object may communicate with a local transportation management server and provide control of a loading box, which enables to control the opening/closing the loading box of the moving object, to a local transportation management server. Accordingly, the local transportation management server may control opening of a loading box of a moving object, control a freight transfer element and a freight loading arm, while the loading box is opened, and load corresponding freight onto the loading box of the moving object. Next, the local transportation management server may control closing of the loading box and return the control to the freight transfer moving object.

As another example, the freight transfer apparatus may include a freight transfer robot device. The freight transfer robot device may be configured to move along a freight transfer element and a temporary freight rack. As an example, the movement of the freight transfer robot device may be controlled through a local transportation management server, and as described above, freight carried by the freight transfer robot device may be loaded to a freight transfer moving object through the control of a loading box.

Although, in an embodiment of the present disclosure, a freight transfer apparatus is exemplified to be provided in a freight transfer moving object stop facility, the present disclosure is not limited thereto, and a freight transfer apparatus may be applied to a freight transfer air vehicle stop facility. In addition, when a freight transfer apparatus is applied to a freight transfer air vehicle stop facility, various modifications are applicable by reflecting characteristics of the freight transfer air vehicle stop facility or a freight transfer air vehicle.

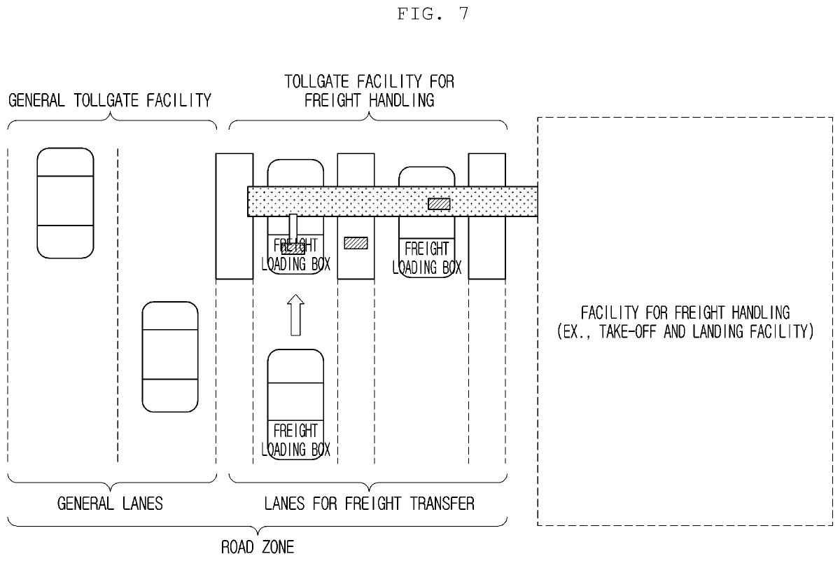

FIG. 7 is a view illustrating a structure of a tollgate facility for freight handling to which a multimodal transportation system is applied according to another embodiment of the present disclosure.

Referring to FIG. 7, a tollgate facility for freight handling may be provided within a road zone and be connected with a freight handling facility. As an example, a freight handling facility may be a facility, via which freight is transported from a departure point to a destination, and include an apparatus capable of providing allocated freight to a freight transfer moving object that passes the tollgate facility for freight handling. As an example, the freight handling facility may include the take-off and landing facility described above. Herein, as described above, the take-off and landing facility may include at least one of a freight transfer moving object stop facility, a freight transfer air vehicle stop facility, a freight standby facility, and a freight transfer apparatus.

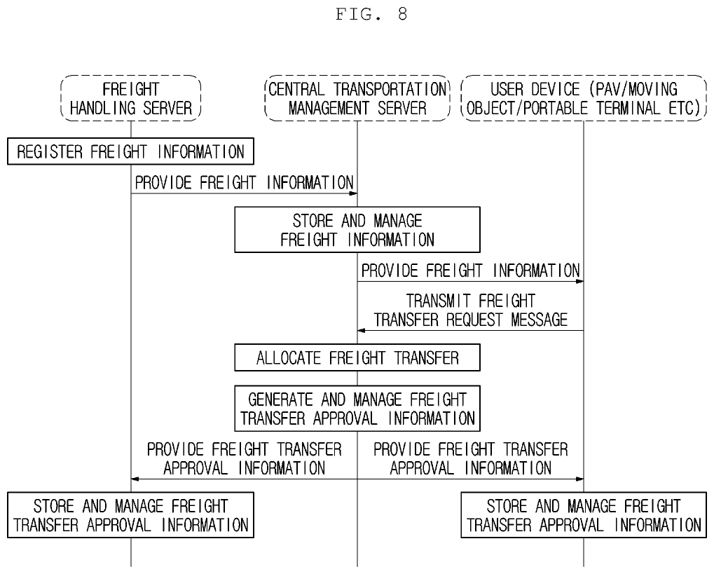

FIG. 8 illustrates an operation of allocating freight in a multimodal transportation system according to an embodiment of the present disclosure.

Referring to FIG. 8, a central transportation management server provided in a multimodal transportation system may be connected with a freight handling server. The freight handling server may register and manage information (freight information) that is basically necessary to transport freight from a departure point to a destination. Herein, the freight information may include an identifier of freight, a departure point, a destination, information on a sender, information on a receiver, a type of freight, a size of freight and the like. Although, in an embodiment of the present disclosure, a freight handling server is exemplified to register and manage freight information, the present disclosure is not limited thereto and various modifications are possible by considering an operation of the conventional server apparatus for handling freight.

A freight handling server may provide freight information, which is registered and managed, to a central transportation management server. The central transportation management server may store and manage freight information. In particular, the central transportation management server may provide an environment in which freight may be transferred through a freight transfer air vehicle and a freight transfer moving object, which are operated in a multimodal transportation system.

As an example, the central transportation management server may provide freight information to a user device (e.g., air vehicle, moving object, portable terminal). In addition, the user device may display the received freight information and provide an environment capable of selecting predetermined freight that may be transferred through a personal air vehicle or a moving object. Also, the user device may be configured to transmit a message (hereinafter, referred to as ‘freight transfer request message’) requesting transfer of freight, which is selected by a user, to the central transportation management server. For example, the freight transfer request message may include an identifier of selected freight, an identifier of an entity (personal air vehicle, moving object, etc.) which will transfer, a type of an entity (personal air vehicle, moving object, etc.) which will transfer, information on a transfer departure point, information on a transfer destination, a transfer departure time, a transfer arrival time, and the like. Herein, the information on a transfer departure point and the information on a transfer destination may include information that indicates a take-off and landing facility used as a logistics hub. As another example, since the information on a transfer departure point and the information on a transfer destination may be designated not as a take-off and landing facility but as an initial delivery point of freight, a final destination of freight and the like, the information on a transfer departure point and the information on a transfer destination may include address information of the departure point and address information of the destination.

The central transportation management server may allocate transfer of freight, which is selected by a user, by using information contained in a freight transfer request message. For example, the central transportation management server may identify freight selected by the user and determine an entity (personal air vehicle, moving object, etc.) which will transfer the freight, and a departure point and a destination of the freight transfer.

In addition, based on information thus determined, the central transportation management server may configure freight transfer approval information. As an example, the transfer approval information may include an identifier of freight, an identifier of an entity (personal air vehicle, moving object, etc.) which will transfer, a type of an entity (personal air vehicle, moving object, etc.) which will transfer, information on a transfer departure point, information on a transfer destination, a transfer departure time, a transfer arrival time, and a result of freight transfer approval.

The central transportation management server may provide the freight transfer approval information to a user device (e.g., personal air vehicle, moving object, portable terminal). In response to this, the user device (e.g., personal air vehicle, moving object, portable terminal) may store and manage the freight transfer approval information and be allocated a freight transfer air vehicle stop zone by using the freight transfer approval information while entering a take-off and landing facility.

Also, the central transportation management server may provide the freight transfer approval information to a freight handling server, and the freight handling server may store and manage the freight transfer approval information.

Although a central transportation management server has been described to provide freight transfer approval information to a user device, the present disclosure is not limited thereto, and various modifications are applicable as long as freight transfer approval information may be managed. As an example, the central transportation management server may configure a freight transfer response message, which includes an identifier of a freight transfer request message and a result of freight transfer approval, and provide the freight transfer response message to a user device (e.g., personal air vehicle, moving object, portable terminal). In response to this, the user device may confirm, based on an identifier of the freight transfer request message, an identifier of freight, an identifier of an entity (personal air vehicle, moving object, etc.) which will transfer, a type of an entity (personal air vehicle, moving object, etc.) which will transfer, information on a transfer departure point, information on a transfer destination, a transfer departure time, and a transfer arrival time and configure and store freight transfer approval information.

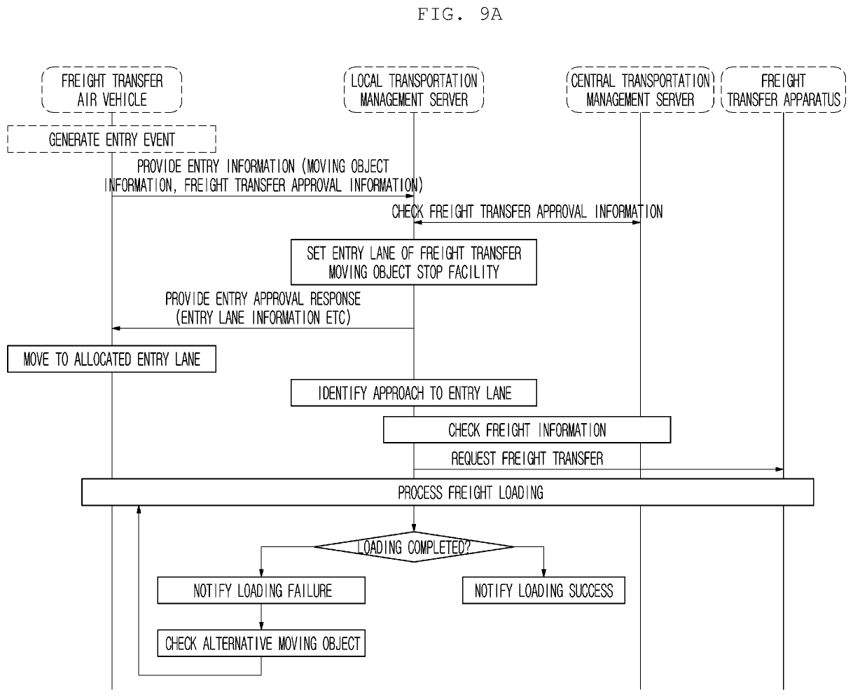

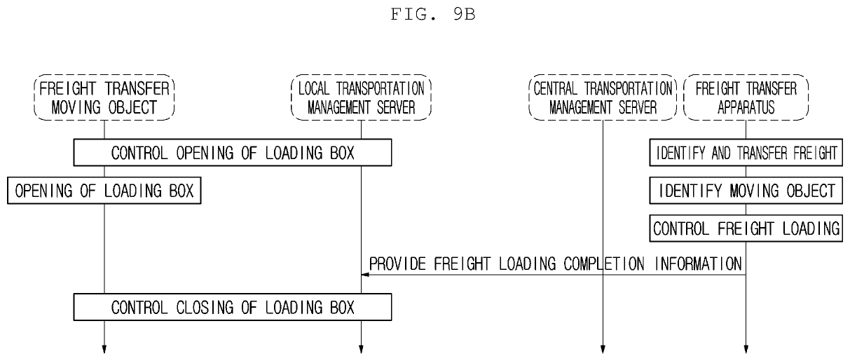

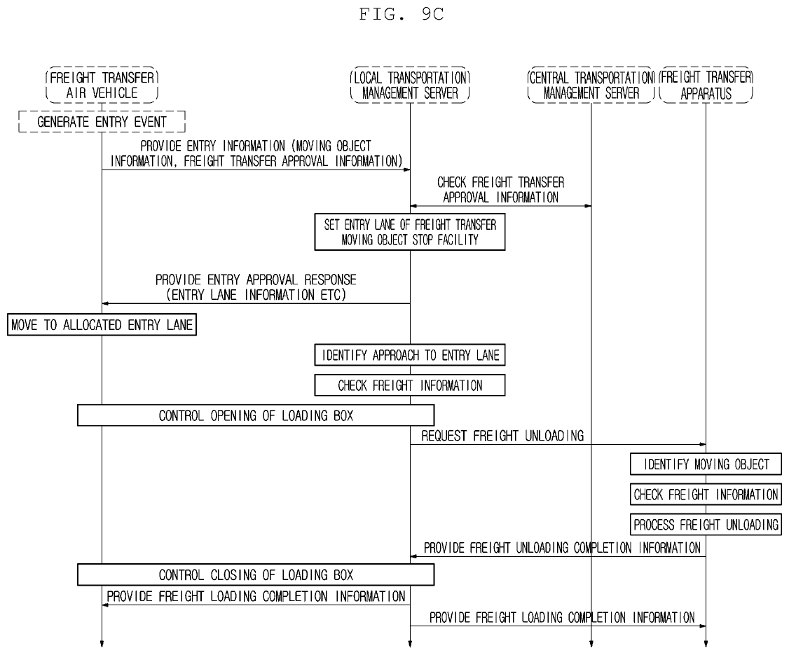

FIGS. 9A to 9C illustrate an operation of processing freight transfer in a multimodal transportation system according to an embodiment of the present disclosure.

FIGS. 9A to 9C illustrate an operation of processing freight transfer of a freight transfer moving object in a multimodal transportation system. Particularly, FIGS. 9A and 9B illustrate an operation of loading freight in a freight transfer moving object, and FIG. 9C illustrates an operation of unloading freight from a freight transfer moving object.

First, referring to FIG. 9A, a freight transfer moving object may provide entry information to a local transportation management server, when entering or approaching a take-off and landing facility. As an example, the entry information may be provided based on an entry event. By means of an apparatus which is provided in the take-off and landing facility in order to detect entry or exit of a moving object, the moving object may confirm entry into the take-off and landing facility and generate an entry event in response thereto. As another example, when the moving object approaches a predetermined distance (e.g., 1 km) from the take-off and landing facility, the moving object may generate an entry event.

Herein, the entry information may include freight transfer approval information together with information on the moving object (identifier of the moving object, type of the moving object, user of the moving object and the like). A local transportation management server may transmit the freight transfer approval information to a central transportation management server and request confirmation of the freight transfer approval information.

In case the freight transfer approval information is confirmed to be valid information, the local transportation management server may check a condition of an entry lane provided in a freight transfer moving object stop facility and set an entry lane to which a corresponding freight transfer moving object may move. Herein, based on a condition of an entry lane, the local transportation management server may set an entry lane to which a moving object may move. As another example, the local transportation management server may set an entry lane through communication with a moving object. For example, the local transportation management server may provide a condition of an entry lane to a moving object and provide an environment in which a user may set an entry lane. That is, a moving object may provide a condition of an entry lane to a user through a display, and when an entry lane is selected by the user, the moving object may transmit information of the selected entry lane to the local transportation management server.

In an embodiment of the present disclosure, a condition of an entry lane may include whether or not there is a moving object in the entry lane, the number of moving objects that enter or stand by on the entry lane, and the like.

Furthermore, the freight transfer approval information may further include information that indicates whether the moving object is a moving object that will load freight or a moving object that is already loaded with freight. As FIG. 9A exemplifies an operation of loading freight in a freight transfer moving object, the freight transfer approval information described above includes information indicating that the moving object will load freight.

Next, the local freight management server may transmit an entry response to the moving object. Herein, the entry response may include entry lane information and the like. In response to this, the moving object may enter a corresponding zone based on the entry lane information. Herein, the local transportation management server may check whether or not the moving object enters and information on the lane that the moving object enters and the like through an access controller installed in a take-off and landing facility.

Next, the local transportation management server may check freight information for freight that is to be loaded to the moving object. As an example, the local transportation management server may request and receive freight information from the central transportation management server. As another example, while checking the freight transfer approval information, the local transportation management server may receive and temporarily store freight information and identify the freight information for freight to be loaded to the moving object by checking the temporarily stored freight information.

The freight to be loaded to the moving object may be loaded in an air vehicle or in another moving object or be prepared in a freight standby zone. Accordingly, the local transportation management server may identify a zone in which freight is present, generate transfer information for transferring the freight from the zone in which the freight is present to the moving object which will be loaded with the freight, and control a freight transfer apparatus that is provided in the take-off and landing facility based on the transfer information. As an example, the freight information may include an identifier of the freight, information on the zone in which the freight is present (e.g., identifier of a stop), information on a zone in which the moving object to be loaded with the freight is present (e.g., identifier of a stop) and the like.

Next, the local transportation management server may request freight transfer to a freight transfer apparatus, and the freight transfer apparatus may process freight loading through communication with the local transportation management server or the moving object. When freight loading is completely processed, the local transportation management server may notify the completion of freight loading. Herein, the local transportation management server may notify the completion of freight loading to a central transportation management server or the moving object. On the other hand, when freight loading to the moving object is not done, the local transportation management server may notify failure of loading. Also, the local transportation management server may check an alternative moving object and process freight loading to the alternative moving object.

FIG. 9B is a view illustrating a detailed operation of the freight loading processing operation of FIG. 9A.

Referring to FIG. 9B, a local transportation management server may identify freight to be loaded and transfer the freight to a zone in which a moving object is present, through control of a freight transfer apparatus. In addition, based on information on a lane that a moving object enters, the freight transfer apparatus may check whether or not the moving object exists in a corresponding zone.

Herein, the local transportation management server may communicate with the moving object in order to load the freight into the moving object. In addition, the local transportation management server may control the opening and closing of a freight loading device of the moving object. For this, the local transportation management server may retrieve control of opening and closing a loading box through communication with the moving object and, when the moving object enters a set lane, may control the loading box in an open state. As another example, the local transportation management server may request the moving object to open the loading box through communication with the moving object and identify an open state of the loading box by receiving a response regarding whether or not the loading box is open.

Next, the freight transfer apparatus may process freight loading, while the loading box of the moving object is open, and provide loading completion information to the local transportation management server. In response to this, the local transportation management server may control the loading box in a closed state and return the control of opening and closing the loading box to the moving object. As another example, the local transportation management server may request the moving object to close the loading box.

In addition, the local transportation management server may provide freight loading completion information to the moving object and a central transportation management server. As an example, the freight loading completion information may include freight information, freight loading time information and the like.

Referring to FIG. 9C, a freight transfer moving object may provide entry information to a local transportation management server, when entering or approaching a take-off and landing facility. As an example, the entry information may be provided based on an entry event. By means of an apparatus which is provided in the take-off and landing facility in order to detect entry or exit of a moving object, the moving object may confirm entry into the take-off and landing facility and generate an entry event in response thereto. As another example, when the moving object approaches a predetermined distance (e.g., 1 km) from the take-off and landing facility, the moving object may generate an entry event.

Herein, the entry information may include freight transfer approval information together with information on the moving object (identifier of the moving object, type of the moving object, user of the moving object and the like). A local transportation management server may transmit the freight transfer approval information to a central transportation management server and request confirmation of the freight transfer approval information.

Furthermore, the freight transfer approval information may further include information that indicates whether the moving object is a moving object that will load freight or a moving object that is already loaded with freight. As FIG. 9B exemplifies an operation of unloading freight from a freight transfer moving object, the freight transfer approval information described above includes information indicating that the moving object is already loaded with the freight.

In case the freight transfer approval information is confirmed to be valid information, the local transportation management server may check a condition of an entry lane provided in a freight transfer moving object stop facility and set an entry lane to which a corresponding freight transfer moving object may move. Although, in an embodiment of the present disclosure, a local transportation management server is exemplified to set an entry lane to which a moving object is to move, based on a condition of the entry lane, the present disclosure is not limited thereto and various modifications may be possible. As another example, the local transportation management server may set an entry lane through communication with a moving object. For example, the local transportation management server may provide a condition of an entry lane to a moving object and provide an environment in which a user may set an entry lane. That is, a moving object may provide a condition of an entry lane to a user through a display, and when an entry lane is selected by the user, the moving object may transmit information of the selected entry lane to the local transportation management server.

Next, the local freight management server may transmit an entry response to the moving object. Herein, the entry response may include entry lane information and the like. In response to this, the moving object may enter a corresponding zone based on the entry lane information. Herein, the local transportation management server may check whether or not the moving object enters and information on the lane that the moving object enters and the like through an access controller installed in a take-off and landing facility.

Next, the local transportation management server may check freight information for freight that is to be unloaded from the moving object. As an example, the local transportation management server may request and receive freight information from the central transportation management server. As another example, while checking the freight transfer approval information, the local transportation management server may receive and temporarily store freight information and identify the freight information for freight to be unloaded from the moving object by checking the temporarily stored freight information.

Herein, the local transportation management server may communicate with the moving object in order to unload the freight from the moving object. In addition, the local transportation management server may control the opening and closing of a freight loading device of the moving object. For this, the local transportation management server may retrieve control of opening and closing a loading box through communication with the moving object and, when the moving object enters a set lane, may control the loading box in an open state. As another example, the local transportation management server may request the moving object to open the loading box through communication with the moving object and identify an open state of the loading box by receiving a response regarding whether or not the loading box is open.

Next, in order to unload the freight from the moving object, the local transportation management server may request a freight transfer apparatus to unload the freight, and the freight transfer apparatus may check a lane, in which the moving object is present, and identify a moving object that stops on the identified lane. In addition, information on freight loaded in the moving object may be identified, and it is checked whether or not the freight is identical with the freight to be unloaded, and then unloading of the freight present in the loading device may be processed.

Next, the freight transfer apparatus may provide information on the completion of unloading freight from the moving object to the local transportation management server. In response to this, the local transportation management server may control the loading box in a closed state and return the control of opening and closing the loading box to the moving object. As another example, the local transportation management server may request the moving object to close the loading box.

In addition, the local transportation management server may provide freight unloading completion information to the moving object and a central transportation management server. As an example, the freight loading completion information may include freight information, freight loading time information and the like.

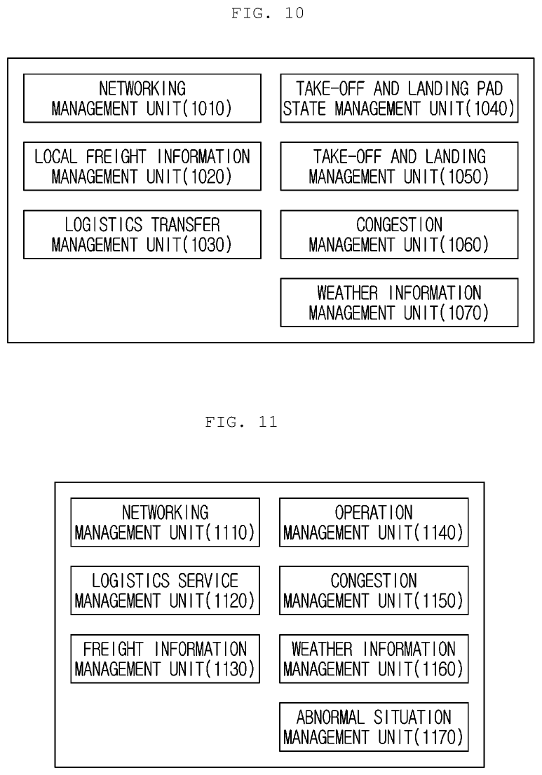

FIG. 10 is a block diagram illustrating a configuration of a local transportation management server provided in a personal air vehicle control system according to an embodiment of the present disclosure.

Referring to FIG. 10, a local transportation management server may include a networking management unit 1010, a local freight information management unit 1020, and a logistics transfer management unit 1030. The networking management unit 1010 may manage the connection and maintenance with the central transportation management server and the connection and maintenance with a neighboring local transportation management server. In addition, the networking management unit 1010 may manage connection with a moving object or a personal air vehicle.

In particular, the local freight information management unit 1020 may perform overall freight handling in a local transportation management server. Specifically, the local freight information management unit 1020 may confirm freight transfer approval information, which is provided from a freight transfer air vehicle (or freight transfer moving object), and determine the validity of the freight transfer approval information via communication with a central transportation management server. In addition, the local freight information management unit 1020 may determine, based on occupancy information of a stop zone, a stop to be allocated to a freight transfer air vehicle (or freight transfer moving object). Also, the local freight information management unit 1020 may manage information regarding in which area of a take-off and landing facility each piece of freight is located.

Also, the local freight information management unit 1020 may execute an operation of checking freight information via communication with the central transportation management server and, when freight loading or unloading of a freight transfer air vehicle (or freight transfer moving object) is completed, may provide corresponding information (e.g., freight loading completion information, freight unloading completion information) to the central transportation management server.

The logistics transfer management unit 1030 may process an operation of transferring freight using a transfer apparatus provided in a take-off and landing facility. As an example, the logistics transfer management unit 1030 may identify a zone, in which freight is present, through linkage with the local freight information management unit 1020, and determine transfer information for transferring the freight from the zone in which the freight is present to an air vehicle (or moving object) which will be loaded with the freight or transfer information for transferring the freight from an air vehicle (or moving object) which is loaded with the freight to a target entity (air vehicle or moving object) to which the freight is to be loaded. Also, the logistics transfer management unit 1030 may process an operation of transferring freight by controlling a transfer apparatus provided in a take-off and landing facility based on transfer information.

In addition, considering a structure of a take-off and landing facility, a local transportation management unit may include at least one of a take-off and landing pad state management unit 1040, a take-off and landing management unit 1050, a congestion management unit 1060 and a weather information management unit 1070.

Based on the structure of a take-off and landing facility, the take-off and landing pad state management unit 1040 may monitor and manage an occupancy state of each zone included in a take-off and landing pad and a stop. To this end, the take-off and landing facility may be equipped with an apparatus capable of detecting an occupancy state of each zone, and such an apparatus may be connected with the take-off and landing pad state management unit 1040. As an example, the apparatus may include a sensor capable of checking whether or not an air vehicle or a moving object enters. As another example, the apparatus may include a camera device and an identification module that is capable of detecting an identifier of an air vehicle or a moving object which enters the zone by analyzing an image received from the camera device.

As an example, the take-off and landing pad state management unit 1040 may manage identification numbers of stops and take-off and landing pads, which are included in the take-off and landing facility, and also manage information on a moving object or an air vehicle, which stops at a stop or a take-off and landing pad.

The take-off and landing management unit 1050 may execute such operations as management of take-off and landing approval for an air vehicle, management of information on a personal air vehicle for which landing is approved, and management of information on a personal air vehicle that enters a landing pad. Also, the take-off and landing management unit 1050 may receive, from the central transportation management server, and confirm information on a waypoint of a personal air vehicle in operation, information on a destination, and expected arrival time at a take-off and landing facility.

In addition, the take-off and landing management unit 1050 may store and manage information on a personal air vehicle, for which a take-off or landing approval is requested, and user information. For example, the take-off and landing management unit 1050 may temporarily store information on a personal air vehicle, for which a take-off approval is requested, and user information and, when the personal air vehicle enters an air vehicle operation zone, may deliver the information on the personal air vehicle and the user information to a central transportation management server and then delete the temporarily stored information. In addition, the take-off and landing management unit 1050 may store information on a personal air vehicle, for which a landing approval is requested, and user information and, when the personal air vehicle enters a take-off and landing field or a stop, may store and manage the information on the personal air vehicle and the user information. Furthermore, when the personal air vehicle, which was present in the take-off and landing field or the stop, goes out of the take-off and landing field or the stop through a road zone, the take-off and landing management unit 1050 may delete the information on the personal air vehicle and the user information.

The congestion management unit 1060 may check and manage a degree of congestion for a corresponding take-off and landing facility based on occupancy information of the take-off and landing facility and reservation information of a personal air vehicle. Specifically, the congestion management unit 1060 may receive an occupancy state of a take-off and landing facility, that is, a take-off and landing pad and a stop from the take-off and landing pad state management unit 1040 and check a degree of congestion by using the occupancy state of the take-off and landing pad and the stop.

Also, the congestion management unit 1060 may receive, from the take-off and landing management unit 1050, information on a waypoint of a personal air vehicle in operation, information on a destination, and expected arrival time at a take-off and landing facility. Also, the congestion management unit 1060 may check and manage a degree of congestion for the take-off and landing facility by reflecting waypoint information, destination information and expected arrival time. As an example, the congestion management unit 1060 may calculate a degree of congestion for a take-off and landing facility every predetermined time (e.g., 10 minutes, 30 minutes, 1 hour) by reflecting an expected arrival time of a personal air vehicle based on a current occupancy state of the take-off and landing facility.

The weather information management unit 1070 may receive and store central weather information provided by the central transportation management server. In addition, a take-off and landing facility may be equipped with at least one weather observation device, and local weather information, which is identified through the weather observation device, may be provided to the weather information management unit 1070. Based on this, the weather information management unit 1070 may store and manage local weather information and provide the local weather information to the central control server.

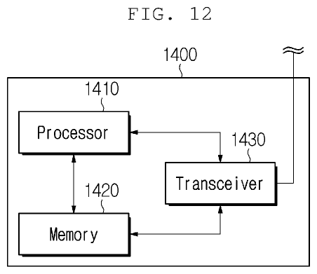

FIG. 11 is a block diagram illustrating a configuration of a central transportation management server provided in a personal air vehicle control system according to an embodiment of the present disclosure.

Referring to FIG. 11, the central transportation management server may include a networking management unit 1110, a logistics service management unit 1120, and a freight information management unit 1130.

The networking management unit 1110 may manage the connection and maintenance with a local control server and the connection and maintenance with a neighboring local control server. In addition, the networking management unit 1110 may manage connection with a moving object or a personal air vehicle and especially manage connection and maintenance with a personal air vehicle in an air vehicle operation zone through a control channel.

The logistics service management unit 1120, which is a component unit for controlling an overall operation of logistics service managed in a multimodal transportation system, may set up a service for processing freight delivery between air vehicles, freight delivery between an air vehicle and a moving object, and freight delivery between moving objects, and may execute an operation for providing such a service. As an example, the logistics service management unit 1120 may receive freight transfer through a personal air vehicle, a moving object and the like and allocate the received freight to a personal air vehicle, a moving object and the like. Also, the logistics service management unit 1120 may manage information of users who use a logistics service.

The freight information management unit 1130 may store and manage freight information that is generated when a multimodal transportation system performs and manages a logistics service. As an example, the freight information management unit 1130 may store and manage the above-described freight transfer approval information, freight information, freight loading completion information, freight unloading completion information and the like.

In addition, the central transportation management server may include at least one of an operation management unit 1140, a congestion management unit 1150, a weather information management unit 1160, and an abnormal situation management unit 1170.

The operation management unit 1140 may manage information related to an operation of a personal air vehicle that enters an air vehicle operation zone. For example, the operation management unit 1140 may store and manage the departure point information, destination information and real-time location information of the personal air vehicle.

The operation management unit 1140 may check and store charging information for a personal air vehicle that enters and exits an air vehicle operation zone.

The congestion management unit 1060 may check and manage congestion information of each section in an air vehicle operation zone based on the departure point information, destination information and real-time location information of a personal air vehicle.

The weather information management unit 1160 may check and store central weather information. In addition, the weather information management unit 1160 may store central weather information in the local control server. The weather information management unit 1160 may receive and store local weather information from the local control server.

The abnormal situation management unit 1170 may monitor whether or not an abnormal situation occurs in a specific location or section, based on congestion information of each section in an air vehicle operation zone and central weather information. When an abnormal situation occurs, the abnormal situation management unit 1170 may transmit an event of occurrence of the abnormal situation to a personal air vehicle or the local control server.

FIG. 12 is a view illustrating an apparatus configuration according to an embodiment of the present invention.

Referring to FIG. 12, the apparatus may include at least one of the above-described moving object, a device, a server and an RSU. In other words, the apparatus may be configured to communicate and work with another device. The present disclosure is not limited to the above-described embodiment. For example, for the above-described operation, an apparatus 1400 may include one or more among a processor 1410, a memory 1420, and a transceiver 1430. In other words, the apparatus may include a necessary configuration for communicating with another apparatus. In addition, the apparatus may include another configuration apart from the above-described configuration. In other words, the apparatus may have a configuration which includes the above-described apparatus for communicating with another device but is not limited thereto, and may be operated based on what is described above.

Although the exemplary methods of embodiments of the present disclosure described above are represented by a series of acts for clarity of explanation, they are not intended to limit the order in which the steps are performed, and if necessary, each step may be performed simultaneously or in a different order. In order to implement a method according to embodiments of the present disclosure, the illustrative steps may include an additional step or exclude some steps while including the remaining steps. Alternatively, some steps may be excluded while additional steps are included.

The various exemplary embodiments of the disclosure are not intended to be all-inclusive and are intended to illustrate representative aspects of the disclosure, and the features described in the various exemplary embodiments may be applied independently or in a combination of two or more. In addition, the various exemplary embodiments of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays, a general processor, a controller, a microcontroller, a microprocessor, and the like may be used for implementation.

The scope of the present disclosure includes software or machine-executable instructions (for example, an operating system, applications, firmware, programs, etc.) that enable operations according to the methods of various exemplary embodiments to be performed on a device or computer, and a non-transitory computer-readable medium in which such software or instructions are stored and are executable on a device or computer.

What is claimed is:

1. A method for multimodal transportation in a multimodal transportation system, the method comprising:
confirming freight transfer approval information provided by a freight transfer object that approaches a multimodal transportation facility;
setting an entry lane for freight handling in a stop facility in response to a demand for freight handling of the freight transfer object; and
controlling freight loading or unloading of the freight transfer object that passes the set entry lane for freight handling.

2. The method of claim 1, wherein setting the entry lane for freight handling includes:
setting the entry lane among a plurality of entry lanes for freight handling, the plurality of entry lanes being prepared in the multimodal transportation system; and
providing the entry lane to the freight transfer object.

3. The method of claim 2, wherein controlling the freight loading or unloading of the freight transfer object comprises loading or unloading freight of the freight transfer object located on the entry lane for freight handling by controlling a freight transfer apparatus.

4. The method of claim 3, wherein loading or unloading the freight of the freight transfer object comprises transferring the freight to the freight transfer object located on the entry lane for freight handling by controlling a freight transfer element provided in the freight transfer apparatus.

5. The method of claim 4, wherein loading or unloading the freight of the freight transfer object comprises:
transferring the freight to the entry lane for freight handling by controlling the freight transfer element; and
loading the freight located in the freight transfer element by controlling a loading arm provided in the freight transfer apparatus.

6. The method of claim 4, wherein loading or unloading the freight of the freight transfer object comprises:
transferring the freight to the entry lane for freight handling by controlling the freight transfer element; and
transferring the freight to a temporary freight rack adjacent to the freight transfer object.

7. The method of claim 2, wherein controlling the freight loading or unloading of the freight transfer object comprises:
detecting a state in which the freight transfer object stops on the entry lane for freight handling;
unloading the freight from a loading device of the freight transfer object; and
transferring the freight by controlling a freight transfer element.

8. The method of claim 7, wherein controlling the freight loading or unloading of the freight transfer object comprises:
requesting the freight transfer object to switch the loading device to an open or closed state; and
confirming the open or closed state of the loading device.

9. The method of claim 7, wherein controlling the freight loading or unloading of the freight transfer object comprises:
retrieving, from the freight transfer object, control of the loading device that controls opening or closing of the loading device provided in the freight transfer object; and
returning, to the freight transfer object, the control of the loading device that controls opening or closing of the loading device provided in the freight transfer object.

10. The method of claim 1, wherein the setting of the freight transfer approval information includes:
providing freight information on at least one piece of transferred freight;
determining at least one piece of freight that is to be transferred by the freight transfer object; and
generating the freight transfer approval information corresponding to the at least one piece of freight that is determined.

11. The method of claim 1, wherein the freight transfer approval information comprises an identifier of the freight, an identifier of an object that will transfer the freight, information on a departure point of transfer, information on a destination of transfer, a departure time of transfer, or an arrival time of transfer.

12. The method of claim 1, wherein confirming the freight transfer approval information comprises receiving a message that includes the freight transfer approval information from the freight transfer object.

13. The method of claim 12, wherein the message includes a second message transmitted from a personal air vehicle and requests entry into the multimodal transportation facility.

14. The method of claim 12, wherein the message includes a second message transmitted from a moving object and notifies entry into the multimodal transportation facility.

15. The method of claim 1, wherein the freight transfer object comprises a freight transfer personal air vehicle or a freight transfer moving object.

16. The method of claim 15, further comprising a freight stop zone comprising a freight air vehicle stop zone in which the freight transfer personal air vehicle stops or a freight moving object stop zone in which the freight transfer moving object stops.

17. A multimodal transportation system for processing freight transportation through a freight transfer object, the system comprising:
a multimodal transportation facility including a stop facility, an entry lane for freight handling, and a freight transfer apparatus for transferring freight to the entry lane for freight handling; and
a transportation management server configured to manage freight loading or unloading of the freight transfer object and to control freight transfer of the freight transfer apparatus.

18. A freight transfer object configured to process freight transfer, the freight transfer object comprising:
a communication unit;
a storage medium; and
a processor configured to:
determine freight to be loaded or unloaded based on freight information provided by a transportation management server;
identify an entry lane for freight handling to be used to enter a multimodal transportation facility; and
process loading or unloading of the freight.

19. A transportation management server apparatus in a multimodal transportation system, the apparatus comprising:
a communication unit;
a storage medium; and
a processor configured to:
check and manage freight information for freight handled through the multimodal transportation system;
check a condition of a stop facility and a condition of an entry lane for freight handling;
control freight loading or unloading of a freight transfer object; and
control a freight transfer apparatus configured to transfer freight to the entry lane for freight handling.

20. A transportation management server apparatus in a multimodal transportation system, the apparatus comprising:
a communication unit;
a storage medium; and
a processor configured to:
provide freight information for freight to be handled through the multimodal transportation system;
identify freight that is to be transferred through at least one freight transfer object; and
provide information on the identified freight.
